(19) United States
(12) Patent Application Publication
(10) Pub. No.: US 2020/0055778 A1
(43) Pub. Date: Feb. 20, 2020

(54) SYNTHETIC MARBLE ITEMS AND METHODS OF MAKING THEM

(71) Applicant: IMERTECH SAS, Paris (FR)

(72) Inventor: Alexandre SEVAGEN, Limoges (FR)

(21) Appl. No.: 16/347,206

(22) PCT Filed: Nov. 3, 2017
(86) PCT No.: PCT/EP2017/078177

§ 371 Date: May 3, 2019

(30) Foreign Application Priority Data
Nov. 4, 2016 (EP) 16306450.4

(51) Int. Cl. C04B 28/18; C04B 14/28; C04B 40/02; C04B 40/00

(52) U.S. Cl. CPC C04B 28/188; C04B 14/28; C04B 2111/00482; C04B 40/0082; C04B 40/0231

(57) ABSTRACT

In an aspect, there is provided a shaped item comprising a synthetic marble-like material. In an aspect, there is provided a method for producing a shaped item comprising a synthetic marble-like material.

### BACKGROUND

Ceramic items are used in large variety of fields. In sanitary ware, which includes items such as shower receivers, wash basins and toilets, they have been used for many years. Ceramics have properties that lend themselves to these items—they have high strength and durability, do not absorb water, and are hygienic. However, ceramics have their drawbacks in that they can be difficult to shape into modern designs with precise angles and very flat surfaces. The current technology to shape ceramic sanitary ware is slip casting in a plaster mould and pouring. The way to make the shell is the result of sucking water by the plaster mould and building a 6 to 8 mm layer of consolidated product. Excess of slip is poured away, and then after a strengthening time, the product is demoulded. Then the product is dried and fired. However difficulties arise, since the moisture content in consolidated layer after casting can be inconsistent (due to angles, difference of suctions by the plaster, etc.) and can create cracks or deformation when drying and additional change of shrinkage when firing. As a result, it is very difficult to get sharp angles and perfectly flat surfaces.

In recent years, sanitary ware manufacturers have developed mineral-resin composites. Mineral-resin composites have advantages over ceramics (i.e. pure ceramic materials) in that they are more easily formed into complex shapes, are less dense and easy to colour. However, they do not have all the advantages of ceramics, since they are often less durable, less strong and not as hygienic, and sometimes contain carbon-derived materials. Mineral-resin composites also do not typically have the same ‘feel’ to consumers on touching them with skin, i.e. the characteristic ‘cold’ feeling a pure ceramic will have.

In other fields, too, there is a desire to produce complex-shaped items, which have the physical characteristics of ceramics. However, with the limitations of producing ceramics, sometimes this can be difficult and complex.

There is therefore a desire to produce items that have certain physical characteristics of ceramics, such as the strength, durability, water-resistance, and/or ‘feel’, yet are in any desired shape, and easy to produce.

### SUMMARY OF THE INVENTION

In an aspect, there is provided a shaped item comprising a synthetic marble-like material.

In an aspect, there is provided a method for producing a shaped item comprising a synthetic marble-like material.

### BRIEF DESCRIPTION OF THE FIGURES

FIGS. 1A to 1F illustrate schematically steps in a process for forming a shaped item according to the present invention.

### DETAILED DESCRIPTION

In an aspect, there is provided a shaped item comprising a synthetic marble-like material. The synthetic marble-like material may comprise, consist essentially of or consist of inorganic material. The synthetic marble-like material may be substantially free (e.g. contain less than 5 wt %, e.g. less than 2 wt %, e.g. less than 1 wt %) or free of organic polymeric material (i.e. polymers having C—C bonds within its structure), e.g. which forms a matrix around the inorganic components, although the synthetic marble-like material may still contain organic, e.g. polymeric, filler particles.

In an aspect, there is provided a method for producing a shaped item comprising a synthetic marble-like material.

The shaped item may be an item having a feature selected from a flat surface, a concave surface, a convex surface, an aperture therein, which may extend partially or completely through the shaped item, and two planes that meet at an angle. The two planes may meet at an angle that is selected from perpendicular (i.e. 90°), acute (i.e. less than 90°) obtuse (i.e. more than 90° and less than 180°) and a reflex angle (i.e. an angle of more than 180° and less than 360)° (all angles as measured through the item). The method described here allows objects having two planes at precise angles to be created. The shaped item may, for example, have a concave surface and an aperture extending from the concave surface into the shaped item, optionally entirely through the shaped item. The concave surface may serve, in use, for example, to collect liquid, which then may drain away via the aperture. The shaped item may, for example, have a concave surface and an aperture extending from the concave surface into the shaped item, optionally entirely through the shaped item.

The shaped item may be an item of sanitary ware or component thereof. In an embodiment, the item may be a receptacle for holding water. The item, which may be a receptacle, may have an aperture extending at least part way through, optionally all the way through, the item. The sanitary ware item may be selected from a toilet bowl, a shower receiver, a bath tub, a wash bowl, a urinal, a strainer for a urinal, flush tanks for a toilet or a urinal, a sink, a heating element and a countertop. A shower receiver, which also may also be termed a shower tray, may be defined as a base in or on which a user can stand while showering and which may have an aperture extending through the base, to allow water to drain away (in use to a pipe that may be fitted to the base). The shower receiver may have a substantially flat portion, which in use, is for a user to stand upon, and, optionally an upstanding rim extending around the substantially flat portion, and optionally, an aperture is dispose in the substantially flat portion that extends through the shower receiver and to which a pipe or conduit may be fitted, to allow water to drain away.

The shaped item may include or be in the form of a conduit, e.g. a pipe, which may be for fitting to an item of sanitary ware, e.g. to allow water or other fluid to drain away. The pipe may be a hollow cylindrical-shaped object.

The shaped item may also be selected from a heating element, a wall tile, a countertop, a mould for metal forming or casting, insulation panels, a protective covering for a heating element or electricity conductor, and kiln furniture. The kiln furniture may be any suitable item for use in a kiln, e.g. an item for supporting other objects in a kiln while they are fired. The kiln furniture may be in the shape of H-cassettes for supporting ceramic bodies such as roofing tiles. Alternatively, the kiln furniture may be base members for supporting stacks of H-cassettes. The kiln furniture may also be selected from box saggars, plate saggars, batts, plates, cranks, posts and connecting kiln furniture elements. The shaped item may also be an item of tableware, a porcelain statue or decorative figurine.

### Synthetic Marble-Like Material

The synthetic marble-like material may be a composite material, which includes a plurality of filler particles and a plurality of adherent bodies. Both filler particles and adherent bodies are preferably inorganic materials. Each adherent body may include a core comprising an alkali earth metal silicate (e.g. a silicate selected from a calcium silicate and a magnesium silicate), preferably primarily calcium silicate, a silica-containing first or inner layer, and an alkali earth metal carbonate-containing second or outer layer. The alkali earth metal carbonate may be selected from magnesium carbonate and calcium carbonate. The plurality of adherent bodies and the plurality of filler particles together form one or more bonding matrices and the adherent bodies and the filler particles may be substantially evenly dispersed therein and bonded together. The synthetic marble-like material may exhibit one or more substantially marble-like textures, patterns and physical properties.

The synthetic marble-like material may be produced from raw materials that are cost-effective to use, such as calcium silicate- and calcium carbonate-containing materials, for example, ground wollastonite and ground limestone. If desired, the physical appearance and/or mechanical properties of the synthetic marble-like material may be designed as appropriate, for example by using pigments (e.g., black iron oxide, cobalt oxide and chromium oxide) and/or minerals (e.g., quartz, mica and feldspar).

As described herein, the composite material may further comprise a pigment. The pigment may be selected from iron oxide, cobalt oxide, and chromium oxide.

The filler particles may comprise calcium-carbonate, which may include one or more of ground limestone, chalk or marble.

The adherent bodies may have been formed from particles comprising, consisting essentially of or consisting of a calcium silicate (e.g. wollastonite), e.g. by the reaction with CO₂, preferably by a hydrothermal liquid phase sintering process, to form the first or inner layer and the second or outer layer of the adherent bodies.

The weight ratio of adherent bodies:filler particles may be from about 10:90 to 50:50, optionally from 15:85 to 50:50.

The synthetic marble-like material may exhibit a pattern selected from swirls, veins and waves.

Preferably, the adherent bodies have been formed from precursor particles comprising an alkali earth metal silicate (e.g. a silicate selected from a calcium-silicate and a magnesium-silicate), preferably wollastonite particles, which have been reacted with CO₂ to form the silica-containing first or inner layer and the alkali earth metal-carbonate-containing second or outer layer. Preferably, the adherent bodies have been formed from precursor particles comprising wollastonite, which have been reacted with CO₂ to form the silica-containing first or inner layer and the calcium carbonate-containing second or outer layer. The reaction of the alkali earth metal silicate (e.g. the calcium-silicate or a magnesium-silicate, e.g. wollastonite) particles, with CO₂ is preferably by hydrothermal liquid phase sintering (HLPS), which may be gas assisted hydrothermal liquid phase sintering.

The reaction of the precursor particles containing calcium silicate may be described by the following equation:

CaOSiO₂+CO₂→CaCO₃+SiO₂.

The hydrothermal liquid phase sintering may involve curing the precursor particles at a temperature in the range from about 20° C. to about 150° C., optionally for about 1 hour to about 80 hours, under an atmosphere of CO₂, preferably under an atmosphere of water and CO₂, which may having a pressure in the range from about 100 kPa, absolute, to about 515 kPa, absolute, and having a CO₂ concentration ranging from about 10% to about 90%.

The process for preparing the synthetic marble-like material, may comprise:

mixing a particulate composition and a liquid composition to form a slurry mixture, wherein the particulate composition comprises:
a ground calcium silicate, e.g. wollastonite, which may have a median particle size in the range from about 1 μm to about 100 μm, and
a first ground calcium carbonate, which may have a median particle size in the range from about 3 μm to about 7 mm,
and wherein the liquid composition comprises:
water, and
optionally, a water-soluble dispersant;
casting the slurry mixture in a mold (from which the synthetic marble-like material may be removed once formed) or on a substrate (to which the synthetic marble-like material may adhere once formed); and
curing the casted mixture at a temperature in the range from about 20° C. to about 150° C. for about 1 hour to about 80 hours under an atmosphere of water and CO₂ having a pressure in the range from 100 kPa, absolute to about 515 kPa, absolute and optionally having a CO₂ concentration ranging from about 10% to about 90%, preferably by volume, to produce a composite material, which preferably exhibits a marble-like texture and pattern.

The first ground calcium carbonate may comprise particles having a median particle size of from 1 μm to 50 μm, optionally from 5 μm to 50 μm, optionally from 5 μm to 40 μm, optionally from 10 μm to 50 μm, optionally from 10 μm to 40 μm, optionally from 10 μm to 30 μm, optionally from 10 μm to 15 μm. In an embodiment, the particulate composition may comprise a second ground calcium carbonate having substantially smaller or larger median particle size than the first ground limestone. In an embodiment, the particulate composition may comprise a first ground calcium carbonate having a median particle size of from 10 μm to 15 μm and a second ground calcium carbonate having median particle size of 15 μm to 20 μm.

The median particle size of the calcium carbonate may be determined by suitable means, such as sedimentation, e.g. using a commercially available Sedigraph 5100. The measurement by sedimentation of the particulate material may be carried out with the particles in a fully dispersed condition in an aqueous medium using a suitable apparatus, e.g. a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value.

The ground calcium silicate, e.g. wollastonite, may have a median particle size of from 1 μm to about 50 μm. The ground calcium silicate, e.g. wollastonite, may have a bulk density (loose) of about 0.6 g/mL to 0.8 g/mL and/or a bulk density (tapped) of about 1.0 g/mL to 1.2 g/mL and/or a surface area of 1.5 g/mL to about 2 g/mL. A suitable wollastonite is commercially available under the trade name NYAD 400® from Nyco® Minerals.

The water-soluble dispersant may be a polymer salt. The water-soluble dispersant may be present in the slurry in a concentration of from 0.1 wt % to 2 wt % of the liquid composition. The polymer salt may be an acrylic homopolymer salt, which may be defined as a polycarboxylate, with a metal counter ion, which may be a Group I metal, such as sodium. A suitable water-soluble dispersant is available from Dow® under the trade name ACUMER™ 9400.

### A. Gas-Assisted Hydrothermal Liquid Phase Sintering

The adherent bodies may be formed, for example, by a method based on gas-assisted HLPS. In such a method, a porous solid body including a plurality of precursor particles is exposed to a liquid (solvent), which partially saturates the pores of the porous solid body, meaning that the volume of the pores are partially filled with water.

In certain systems such as those forming carbonate, completely filling the pores with water is believed to be undesirable because the reactive gas is unable to diffuse from the outer surface of the porous solid body to all of the internal pores by gaseous diffusion. Instead, the reactant of the reactive gas would dissolve in the liquid and diffuse in the liquid phase from the outer surface to the internal pores, which is much slower. This liquid-phase diffusion may be suitable for transforming thin porous solid bodies but would be unsuitable for thicker porous solid bodies.

In some embodiments, a gas containing a reactant is introduced into the partially saturated pores of the porous solid body and the reactant is dissolved by the solvent. The dissolved reactant then reacts with the at least first chemical element in the precursor particle to transform the peripheral portion of the precursor particle into the first layer and the second layer. As a result of the reaction, the dissolved reactant is depleted from the solvent. Meanwhile, the gas containing the reactant continues to be introduced into the partially saturated pores to supply additional reactant to the solvent.

As the reaction between the reactant and the at least first chemical element of the precursor particles progresses, the peripheral portion of the precursor particle is transformed into the first layer and the second layer. The presence of the first layer at the periphery of the core eventually hinders further reaction by separating the reactant and the at least first chemical element of the precursor particle, thereby causing the reaction to effectively stop, leaving an adherent body having the core as the unreacted center of the precursor particle, the first layer at a periphery of the core, and a second layer on the first layer.

The resulting adherent body includes the core, the first layer and the second layer, and is generally larger in size than the precursor particle, filling in the surrounding porous regions of the porous solid body and possibly bonding with adjacent materials in the porous solid body. As a result, net-shape formation of products may be formed that have substantially the same size and shape as but a higher density than the porous solid body. This is an advantage over traditionally sintering processes that cause shrinkage from mass transport to produce a higher density material than the initial powder compact.

### B. HLPS in an Autoclave

In an exemplary embodiment of the method of HLPS, a porous solid body comprising a plurality of precursor particles is placed in an autoclave chamber and heated. Water as a solvent is introduced into the pores of the porous solid body by vaporizing the water in the chamber. A cooling plate above the porous solid body condenses the evaporated water that then drips onto the porous body and into the pore of the porous solid body, thus partially saturating the pores of the porous solid body. However, the method of introducing water in this example is one of several ways that water can be delivered. For example, the water can also be heated and sprayed. Meanwhile, carbon dioxide as a reactant is pumped into the chamber, and the carbon dioxide diffuses into the partially saturated pores of the porous body. Once in the pores, the carbon dioxide dissolves in the water, thus allowing the reaction between the precursor particles and the carbon dioxide to transform the peripheral portions of the precursor particles into the first and second layers.

As the reaction between the second reactant and the first layer progresses, the second reactant continues to react with the first layer, transforming the peripheral portion of the first layer into the second layer. The formation of the second layer may be by the exo-solution of a component in the first layer, and such a second layer may be a gradient layer, wherein the concentration of one of the chemical elements (cations) making up the second layer varies from high to low as you move from the core particle surface to the end of the first layer. It is also possible that the second layer can be a gradient composition as well, such as when the layers are either amorphous or made up of solid solutions that have either constant or varying compositions.

### C. Infiltration Medium

The infiltration medium used for transportation into at least a portion of the porous matrix includes a solvent (e.g., water) and a reactive species (e.g., CO₂). The solvent can be aqueous or non-aqueous. The solvent can include one or more components. For example, in some embodiments, the solvent can be water and ethanol, ethanol and toluene, or mixtures of various ionic liquids, such as ionic liquids based on alkyl-substituted imidazolium and pyridinium cations, with halide or trihalogenoaluminate anions. Wetting systems are preferred over non-wetting in order to simplify processing equipment.

The solvent should not be chemically reactive with the porous matrix, although the solvent may chemically react with reactive species. The solvent can be removed via a variety of separation methods such as bulk flow, evaporation, sublimation or dissolution with a washing medium, or any other suitable separation method known to one of ordinary skill in the art.

More specifically, the solvent is a liquid at the temperature where the dissolved reactive species react with the porous matrix. This temperature will vary depending on the specific solvent and reactive species chosen. Low temperatures are preferred over higher ones to save energy and simplify processing equipment thereby reducing manufacturing costs.

The role of the solvent contrasts with prior art involving reactive systems, such as, for example, Portland cement, where a solvent such as water reacts with a porous matrix to form products that contain solvent molecules, such as metal hydrates or metal hydroxides, among other precipitation products.

Regardless of the phase of the pure reactive species, the reactive species dissolve in the solvent as neutral, anionic or cationic species. For example, the at least one reactive species can be CO₂, which is a gas at room temperature that can dissolve in water as neutral CO₂ but can create reactive species such as H₃O⁺, HCO₃⁻, H₂CO₃ and CO₃²⁻. Regardless of the initial phase of the reactive species and the solvent in the natural state, the infiltration medium is in a liquid phases in the pores (e.g., interstitial spaces) of a porous matrix.

For example, capillary forces can be used to wick the infiltration medium into a porous matrix spontaneously. This type of wetting occurs when the infiltration medium has a very low contact angle (e.g., <90° C.). In this case, the medium can partially fill (partially saturate) or fully fill (saturate) the pores. The infiltration can also take place in such a manner that the some pores are filled while others are empty and/or partially filled. It is also possible that an infiltrated porous matrix with gradients in pore filling or saturation can be later transformed to one that is uniform via capillary flow. In addition, wetting does not spontaneously occur when the contact angle of the infiltration medium is high (e.g., >90°). In such cases, fluids will not infiltrate the porous matrix unless external pressure is applied. This approach has utility when it is desirable to withdraw the infiltration medium by the release of pressure (e.g., a reaction can be initiated or halted by pressure).

When infiltration is done using spontaneous capillary flow in the pores, the bulk flow ceases when the pores are filled (saturated). During HLPS, the reactive species react with the matrix to form one or more products by the various reactions. The at least one reaction species is depleted from inside the pore space and thus need to be replenished during the course of the reaction. When pores are fully saturated with the infiltration medium, the reactive species must be transported from the infiltration medium external to the porous matrix through the matrix pores. In a quiescent fluid, diffusion is the process by which transport takes place. Thus, for some HLPS methods whose reactions inside the pores are fast relative to all other mass transport processes, the reaction becomes limited by large increases in the porous matrix thickness. In such a case, only the outer portion of the matrix reacts extensively with the reactive species, while inner regions of the porous matrix are either less completely reacted or unreacted. These types of reactions is suitable for preparation of gradient microstructures where the concentrations of products of the HLPS process are higher on the outside portion (near external surface regions) versus the interior of the structure.

The synthetic marble-like materials may display various marble-like patterns, textures and other characteristics, such as veins, swirls and/or waves of various colors that are unique to marble. In addition, the synthetic marble-like materials of the invention exhibit compressive strength, flexural strength and water absorption similar to that of marble.

In certain embodiments, the synthetic marble-like material further includes a pigment. The pigment may be evenly dispersed or substantially unevenly dispersed in the bonding matrices, depending on the desired composite material. The pigment may be any suitable pigment including, for example, oxides of various metals (e.g., iron oxide, cobalt oxide, chromium oxide). The pigment may be of any color or colors, for example, selected from black, white, blue, gray, pink, green, red, yellow and brown. The pigment may be present in any suitable amount depending on the desired synthetic marble-like material, for example in an amount ranging from about 0.0% to about 10% by weight (e.g., about 0.0% to about 8%, about 0.0% to about 6%, about 0.0% to about 5%, about 0.0% to about 4%, about 0.0% to about 3%, about 0.0% to about 2%, about 0.0% to about 1%, about 0.0% to about 0.5%, about 0.0% to about 0.3%, about 0.0% to about 2%, about 0.0% to about 0.1%).

The particle size and particle size distributions of any of the components of the shaped item, such as the marble-like material or the adherent bodies and/or filler particles, may be measured, for example, using laser diffraction in a suitable laser diffraction apparatus. Standard techniques for measuring particle size distribution using laser diffraction are known, for example as described in ASTM UOP856-07, which is incorporated herein by reference. The laser light diffraction measurements in accordance with this standard may be performed, for example, with a Microtrac Model S3500 instrument commercially available from Microtrac Inc., or a Malvern Instruments Mastersizer 3000. Median particle size may be defined as the volume average D50, as measured using laser diffraction in a suitable laser diffraction apparatus. A D50 distribution is defined as 50% of the population of particles having sizes less than the D50 value, and 50% of the population of particles having sizes greater than the D50 value.

Alternatively, where stated, particle size properties referred to herein for the inorganic particulate materials are as measured in a well known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value.

The plurality of adherent bodies may have any suitable median particle size and size distribution dependent on the desired synthetic marble-like material. In certain embodiments, the plurality of adherent bodies have a median particle size in the range of about 1 μm to about 100 μm (e.g., about 1 μm to about 100 μm, about 3 μm to about 100 μm, about 5 μm to about 80 μm, about 5 μm to about 60 μm, about 5 μm to about 50 μm, about 5 μm to about 40 μm, about 5 μm to about 30 μm, about 5 μm to about 20 μm, about 5 μm to about 10 μm, about 10 μm to about 80 μm, about 10 μm to about 70 μm, about 10 μm to about 60 μm, about 10 μm to about 50 μm, about 10 μm to about 40 μm, about 10 μm to about 30 μm, about 10 μm to about 20 μm).

The plurality of filler particles may have any suitable median particle size and size distribution. In certain embodiments, the plurality of filler particles has a median particle size in the range from about 5 μm to about 7 mm (e.g., about 5 μm to about 5 mm, about 5 μm to about 4 mm, about 5 μm to about 3 mm, about 5 μm to about 2 mm, about 5 μm to about 1 mm, about 5 μm to about 500 μm, about 5 μm to about 300 μm, about 20 μm to about 5 mm, about 20 μm to about 4 mm, about 20 μm to about 3 mm, about 20 μm to about 2 mm, about 20 μm to about 1 mm, about 20 μm to about 500 μm, about 20 μm to about 300 μm, about 100 μm to about 5 mm, about 100 μm to about 4 mm, about 100 μm to about 3 mm, about 100 μm to about 2 mm, about 100 μm to about 1 mm).

In certain embodiments, the plurality of adherent bodies have a median particle size in the range from about 1 μm to about 100 μm and the plurality of filler particles have a median particle size in the range from about 1 μm to about 7 mm, optionally about 1 μm to about 4 mm, optionally about 1 μm to about 3 mm, optionally about 1 μm to about 2 mm. In certain embodiments, the plurality of adherent bodies have a median particle size in the range from about 5 μm to about 100 μm and the plurality of filler particles have a median particle size in the range from about 5 μm to about 7 mm, optionally about 5 μm to about 4 mm, optionally about 5 μm to about 3 mm, optionally about 5 μm to about 2 mm.

In certain embodiments, the filler particles are made from one or more of chamottes, feldspars, quartz, kaolins (e.g., hydrous, middle calcined such as metakaolin, or completely calcined), mica, calcium carbonates or any other material used in ceramics such as alumina, corundum, frit (milled or not milled) and glass cullet. In certain preferred embodiments, the filler particles are made from a calcium carbonate-containing material such as limestone (e.g., ground limestone). In certain embodiments, the filler particles are made from one or more of quartz, mica and feldspar (e.g., ground quartz, ground mica, ground feldspar).

In an embodiment, the filler particles comprise a variety of particle sizes and materials. In an embodiment, the filler particles comprise about 7 to 40 wt % of particles having a median particle size of less than 1 μm (e.g. a wollastonite, e.g. a nano HVS wollastonite), about 10 to 60 wt % of particles having a median particle size of 1 to 20 μm (e.g. particles selected from kaolins and/or milled minerals), about 10 to 60 wt % of particles having a median particle size of 20 to 200 μm (e.g. milled minerals, which may be hard minerals), and about 0 to 60 wt % of particles having a median particle size of more than 200 μm (e.g. particles selected from Chamottes, feldspar and quartz particles)

The plurality of adherent bodies may be chemically formed from any suitable precursor materials, for example, from a precursor calcium silicate other than wollastonite. The precursor calcium silicate may include one or more chemical elements of aluminum, magnesium and iron.

Optionally, the plurality of adherent bodies are formed from ground wollastonite; and the filler particles comprise ground limestone.

As used herein, the term “calcium silicate” refers to naturally-occurring minerals or synthetic materials that are comprised of one or more of a group of calcium-silicon-containing compounds including CaSiO₃ (which may be termed as “wollastonite” and sometimes formulated as CaO.SiO₂), Ca₂SiO₄ (which may be termed as “Belite” and sometimes formulated as 2CaO.SiO₂), Ca₃SiO₅ (which may be termed as “Alite” and sometimes formulated as 3CaO.SiO₂), which material may include one or more other metal ions and oxides (e.g., aluminum, magnesium, iron or manganese oxides), or blends thereof, or may include an amount of magnesium silicate in naturally-occurring or synthetic form(s) ranging from trace amount (1%) to about 50% or more by weight.

It should be understood that, compositions and methods disclosed herein can be adopted to use magnesium silicate in place of or in addition to calcium silicate. As used herein, the term “magnesium silicate” refers to naturally-occurring minerals or synthetic materials that are comprised of one or more of a group of magnesium-silicon-containing compounds including, for example, Mg₂SiO₄ (which may be termed as “Fosterite”) and Mg₃Si₄O₁₀(OH)₂) (which may be termed as “Talc”), which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

The weight ratio of (adherent bodies):(filler particles) may be any suitable ratio dependent on the desired composite material, for example, in the range of about (15 to 50):about (50 to 85).

In certain preferred embodiments, the plurality of adherent bodies are prepared by chemical transformation from ground wollastonite (or a non-wollastonite precursor calcium silicate) by reacting it with CO₂, for example via a gas-assisted HLPS process.

In certain embodiments, the synthetic marble-like material is characterized by a compressive strength from about 100 MPa to about 300 MPa (e.g., about 100 MPa to about 250 MPa, about 100 MPa to about 200 MPa, about 100 MPa to about 180 MPa, about 100 MPa to about 160 MPa, about 100 MPa to about 150 MPa, about 100 MPa to about 140 MPa, about 120 MPa to about 300 MPa, about 130 MPa to about 300 MPa, about 140 MPa to about 300 MPa, about 150 MPa to about 300 MPa, about 200 to about 300 MPa).

In certain embodiments, the synthetic marble-like material is characterized by a flexural strength from about 15 MPa to about 40 MPa (e.g., about 15 MPa to about 35 MPa, about 15 MPa to about 30 MPa, about 15 MPa to about 25 MPa, about 15 MPa to about 20 MPa, about 20 MPa to about 40 MPa, about 20 MPa to about 35 MPa, about 20 MPa to about 30 MPa).

The synthetic marble-like material may be a composite material having a compressive strength from about 100 MPa to about 300 MPa and a flexural strength from about 15 MPa to about 40 MPa.

In certain embodiments, the synthetic marble-like material is characterized by water absorption of less than about 10% (e.g., less than about 8%, 5%, 4%, 3%, 2%, 1%), by weight.

In certain embodiments, the composite material has less than about 10% by weight of one or more minerals selected from quartz, mica and feldspar.

The synthetic marble-like material may display any desired textures, patterns and physical properties, in particular those that are characteristic of marble. In certain preferred embodiments, the synthetic marble-like material exhibits a pattern selected from swirls, veins and waves. Other marble-like characteristics include colors (e.g., black, white, blue, gray, pink, green, red, yellow, brown and other colors not found in the natural analogs) and textures.

The synthetic marble-like material may be a composite material comprising:

a plurality of adherent bodies, wherein each adherent body comprises:
a core comprising calcium silicate,
a silica-containing first or inner layer, and
a calcium carbonate-containing second or outer layer; and
a plurality of filler particles,
wherein the plurality of adherent bodies and the plurality of filler particles together form one or more bonding matrices and the adherent bodies and the filler particles are substantially evenly dispersed therein and bonded together, preferably whereby the composite material exhibits one or more substantially marble-like textures, patterns and physical properties. Alternatively, the core may comprise primarily magnesium silicate and a magnesium carbonate-containing second or outer layer.

In certain embodiments, the adherent body of the present invention includes a core, a first layer and a second or encapsulating layer. The first layer may include only one layer or multiple sub-layers and may completely or partially cover the core. The first layer may exist in a crystalline phase, an amorphous phase or a mixture thereof, and may be in a continuous phase or as discrete particles. The second layer may include only one layer or multiple sub-layers and may also completely or partially cover the first layer. The second layer may include a plurality of particles or may be of a continuous phase, with minimal discrete particles.

The adherent body may exhibit any size and any regular or irregular, solid or hollow morphology depending on the intended application. Exemplary morphologies include: cubes, cuboids, prisms, discs, pyramids, polyhedrons or multifaceted particles, cylinders, spheres, cones, rings, tubes, crescents, needles, fibers, filaments, flakes, spheres, sub-spheres, beads, grapes, granulars, oblongs, rods, ripples, etc.

In general, as discussed in greater detail herein, an adherent body is produced from reactive precursor materials (e.g., precursor particles) through a transformation process. The precursor particles may have any size and shape as long as they meet the needs of the intended application. The transformation process generally leads to the corresponding adherent bodies having similar sizes and shapes of the precursor particles.

Precursor particles can be selected from any suitable material that can undergo suitable transformation to form the desired adherent bodies. For example, the precursor particles may include oxides and non-oxides of silicon, titanium, aluminum, phosphorus, vanadium, tungsten, molybdenum, gallium, manganese, zirconium, germanium, copper, niobium, cobalt, lead, iron, indium, arsenic, tantalum, and/or alkaline earth elements (beryllium, magnesium, calcium, strontium, barium and radium).

Example precursor materials include oxides such as silicates, titanates, aluminates, phosphates, vanadates, tungstates, molybdates, gallates, manganates, zirconates, germinates, cuprates, stannates, hafnates, chromates, niobates, cobaltates, plumbates, ferrites, indates, arsenates, tantalates and combinations thereof. In some embodiments, the precursor particles include silicates such as orthosilicates, sorosilicates, cyclosilicates, inosilicates, phyllosilicates, tectosilicates and/or calcium silicate hydrate.

Certain waste materials may be used as the precursor particles for some applications. Waste materials may include, for example, minerals, industrial waste, or an industrial chemical material. Some exemplary waste materials include mineral silicate, iron ore, periclase, gypsum, iron (II) hydroxide, fly ash, bottom ash, slag, glass, oil shells, red mud, battery waste, recycled concrete, mine tailings, paper ash, or salts from concentrated reverse osmosis brine.

Additional precursor particles may include different types of rock containing minerals such as cal-silicate rock, fitch formation, hebron gneiss, layered gneiss, middle member, argillite, quartzite, intermediate Precambrian sediments, dark-colored, feldspathic quartzite with minor limestone beds, high-grade metasedimentry biotite schist, biotite gniss, mica schist, quartzite, hoosac formation, partridge formation, Washington gneiss, Devonian, Silurian greenvale cove formation, ocoee supergroup, metasandstone, metagraywacke, Rangeley formation, amphibolites, calcitic and dolomite marble, manhattan formation, rusty and gray biotite-quartz-feldspar gneiss, and waterford group.

Precursor particles may also include igneous rocks such as, andesite, anorthosite, basinite, boninite, carbonatite and charnockite, sedimentary materials such as, but not limited to, argillite, arkose, breccias, cataclasite, chalk, claystone, chert, flint, gitsone, lighine, limestone, mudstone, sandstone, shale, and siltsone, metamorphic materials such as, but not limited to, amphibolites, epidiorite, gneiss, granulite, greenstone, hornfels, marble, pelite, phyllite, quartzite, shist, skarn, slate, talc carbonate, and soapstone, and other varieties of rocks such as, but not limited to, adamellite, appinite, aphanites, borolanite, blue granite, epidosite, felsites, flint, ganister, ijolite, jadeitite, jasproid, kenyte, vogesite, larvikite, litchfieldite, luxullianite, mangerite, minette, novaculite, pyrolite, rapakivi granite, rhomb porphyry, shonkinite, taconite, teschenite, theralite, and variolite.

The bonding matrix may incorporate one or more filler materials, which are mixed with the precursor materials prior to or during the transformation process to create the synthetic marble-like material. The concentration of adherent bodies in the bonding matrix may vary. For example, the concentration of adherent bodies on a volume basis may be relatively high, wherein at least some of the adherent bodies are in contact with one another. This situation may arise if filler material is incorporated into the bonding matrix, but the type of filler material and/or the amount of filler material is such that the level of volumetric dilution of the adherent body is relatively low. In another example, the concentration of adherent bodies on a volume basis may be relatively low, wherein the adherent bodies are more widely dispersed within the bonding matrix such that few, if any of the adherent bodies are in contact with one another. This situation may arise if filler material is incorporated into the bonding matrix, and the type of filler material and/or the amount of filler material is such that the level of dilution is relatively high.

In general, the filler material may include any one of a number of types of materials that can be incorporated into the bonding matrix. A filler material may be inert or active. An inert material does not go through any chemical reaction during the transformation and does not act as a nucleation site, although it may physically or mechanically interact with the bonding matrix. The inert material may involve polymers, metals, inorganic particles, aggregates, and the like. Specific examples may include, but are not limited to basalt, granite, recycled PVC, rubber, metal particles, alumina particle, zirconia particles, carbon-particles, carpet particles, Kevlar™ particles and combinations thereof. An active material chemically reacts with the bonding matrix during the transformation go through any chemical reaction during the transformation and/or acts as a nucleation site. For example, magnesium hydroxide may be used as a filler material and may chemically react with a dissolving calcium component phase from the bonding matrix to form magnesium calcium carbonate.

The bonding matrix may occupy almost any percentage of the synthetic marble-like material. Thus, for example, the bonding matrix may occupy about 1 vol. % to about 99 vol. % of the synthetic marble-like material (e.g., the volume fraction of the bonding matrix can be less than or equal to about 90 vol. %, 70 vol. %, 50 vol. %, 40 vol. %, 30 vol. %, 20 vol. %, 10 vol. %). A preferred range for the volume fraction of the bonding matrix is about 8 vol. % to about 90 vol. % (e.g., about 8 vol. % to about 80 vol. %, about 8 vol. % to about 70 vol. %, about 8 vol. % to about 50 vol. %, about 8 vol. % to about 40 vol. %), and more preferred range of about 8 vol. % to 30 vol. %.

The synthetic marble-like material may also be porous or non-porous. The degree of porosity depends on a number of variables that can be used to control porosity, such as temperature, reactor design, the precursor material, the amount of liquid that is introduced during the transformation process and whether any filler is employed. Depending on the intended application, the porosity can be set to almost any degree of porosity from about 1 vol. % to about 99 vol. % (e.g., less than or equal to about 90 vol. %, 70 vol. %, 50 vol. %, 40 vol. %, 30 vol. %, 20 vol. %, 10 vol. %). A preferred range of porosity for the synthetic marble-like material is about 1 vol. % to about 70 vol. %, more preferably between about 1 vol. % and about 10 vol. % for high density and durability and between about 50 vol. % and about 70 vol. % for lightweight and low thermal conductivity.

Within the bonding matrix, the adherent bodies may be positioned, relative to each other, in any one of a number of orientations. An exemplary bonding matrix may include fiber- or platelet-shaped adherent bodies in different orientations possibly diluted by the incorporation of filler material, as represented by the spacing between the adherent bodies. For example, a bonding matrix may include fiber-shaped adherent bodies aligned in a one-direction (“1-D”) orientation (e.g., aligned with respect to the x direction). A bonding matrix may include platelet-shaped adherent bodies aligned in a two-direction (“2-D”) orientation (e.g., aligned with respect to the x and y directions). A bonding matrix may include platelet-shaped adherent bodies aligned in a three-direction (“3-D”) orientation (e.g., aligned with respect to the x, y and z directions). A bonding matrix may include platelet-shaped adherent bodies in a random orientation, wherein the adherent bodies are not aligned with respect to any particular direction. A bonding matrix may include a relatively high concentration of platelet-shaped adherent bodies that are aligned in a 3-D orientation. A bonding matrix may include a relatively low concentration of platelet-shaped adherent bodies that are situated in a random orientation (a percolation network). The synthetic marble-like material may achieve the percolation threshold because a large proportion of the adherent bodies are touching one another such that a continuous network of contacts are formed from one end of the material to the other end. The percolation threshold is the critical concentration above which adherent bodies show long-range connectivity with either an ordered or random orientation of adherent bodies. Examples of connectivity patterns can be found in, for example, Newnham, et al., “Connectivity and piezoelectric-pyroelectric composites”, Mat. Res. Bull. vol. 13, pp. 525-536, 1978).

Adherent body orientation can be achieved by any one of a number of processes including, for example, tape casting, extrusion, magnetic field and electric field casting. Pre-forming the precursor in accordance with any one of these methods would occur prior to transforming the precursor particle according to the transformation method described above.

Furthermore, one or multi-level repeating hierarchic structure can be achieved in a manner that can promote dense packing, which provides for making a strong material, among other potential useful, functional purposes. Hierarchy describes how structures form patterns on several length scales. Different types of bonding matrices can be created by varying the matrix porosity and by incorporating core fibers of different sizes. Different kinds of particulate and fiber components can be used with hierarchic structures to fabricate different kinds of structures with different connectivity.

The method of producing the shaped item may involve forming the synthetic marble-like material in a mould from a precursor material. The method may involve providing a mould having the precursor material therein and then curing the precursor material to form the synthetic marble-like material, and removal of the mould. The method of producing the shaped item may involve moulding the precursor material in a mould, optionally drying the precursor material to an extent that the precursor material is self-supporting in the absence of the mould, removal of the mould, and then curing the precursor material to form the synthetic marble-like material. The mould may be intact or it may be broken when removed from the shaped item (or precursor material). The mould may be made of any suitable material, e.g. a porous or non-porous material. The mould may, for example, be a metallic, plastic, e.g. a thermoplastic or a thermoset, a synthetic or natural rubber, or a ceramic material. The mold may, for example, be an aluminium mould. When the precursor material is in the mould, the precursor material may be subjected to pressure and/or vibration to maximise the filling of the internal contours of the mould by the precursor material, so that the shaped item matches as closely as possible the contours of the mould. In an embodiment, the precursor material may be injected into the mould and then dried and/or cured (in or out of the mould) to form the synthetic marble-like material. The use of such moulding techniques for the synthetic marble-like material can make production of shaped items reliable and quick, and allow complex shapes to be formed.

In an embodiment, the precursor material may comprise the filler particles, precursor particles comprising an alkali earth metal silicate (which may be selected from calcium-silicate or a magnesium silicate), a solvent and the precursor material may be injected into a mould. The precursor material may further comprise a gelling agent, which may be a temperature sensitive gelling agent. The precursor material may have a viscosity suitable for low pressure injection moulding, e.g. a viscosity of not more than 10 Pa·s at a shear rate of 100 s⁻¹ at a temperature greater than the gel point of the gelling agent. The precursor may have a solids content of at least 50 vol. %. The gelling agent may comprise a polysaccharide or a mixture of polysaccharides. The gelling agent may be selected from one or more of agar, agarose, and arabic gum.

Optionally, the shaped item may comprise a substrate having a layer of the synthetic marble-like material thereon. The substrate may be any substrate to which the synthetic marble-like material can adhere. The substrate may be comprise an inorganic material or a polymeric material. The substrate may comprise a porous structure, e.g. a foam of an inorganic material, which may be selected from a porous geopolymer, porous concrete, glass foam, glass wool, expanded perlite, expanded clay, consolidated diatomite earth. The shaped item may be produced by providing the substrate, and applying the precursor for the synthetic marble-like material on a surface thereof and curing the precursor to form the synthetic marble-like material. The shaped item may be produced by providing the substrate, which is a porous structure, e.g. a foam, and applying the precursor for the synthetic marble-like material on a surface thereof, and curing the precursor to form the synthetic marble-like material. The shaped item may be produced by providing the substrate, which is a porous structure, e.g. a foam, having open pores on a surface thereof, and applying the precursor for the synthetic marble-like material on the surface having the open pores, such that at least some of the pores are at least partially filled with the precursor material, and curing the precursor to form the synthetic marble-like material. In this way, the synthetic marble-like material is tightly bound to the substrate. The porous structure may act as a structural support for the synthetic marble-like material, which effectively forms a water-tight barrier over a surface of the porous structure.

Preferably, the shaped item comprises a substrate comprising a layer comprising a geopolymer, and a layer comprising synthetic marble-like material, which may or may not be in contact with the layer comprising the geopolymer. Preferably, the shaped item comprises a substrate comprising a geopolymer, the substrate having thereon a synthetic marble-like material. Geopolymers may be defined as inorganic polymers, e.g. polymers formed from inorganic materials that form covalently-bonded, non-crystalline (amorphous) networks. An example of a geopolymer is an aluminosilicate material that have a Si—O—Al framework, or, more specifically, SiO₄ and AlO₄ tetrahedral frameworks linked by shared oxygens. The geopolymer may be a geopolymer selected from a metakaolin MK-750-based geopolymer (which may have the chemical formula (Na,K)—(Si—O—Al—O—Si—O—), ratio Si:Al=2 (range 1.5 to 2.5), a silica-based geopolymer binder (which may have the chemical formula (Na,K)-n(Si—O—)—(Si—O—Al—), ratio Si:Al>20 (range 15 to 40)) and sol-gel-based geopolymer binder (synthetic MK-750) chemical formula (Na,K)—(Si—O—Al—O—Si—O—), ratio Si:Al=2. In an embodiment, the geopolymer may be formed from a dry particulate composition comprising: (i) an alkali metal hydroxide, (ii) an alkali metal silicate, and (iii) an aluminosilicate,

wherein at least 45 t.-% of the aluminosilicate is in an amorphous state, based on the total weight of aluminosilicate in the composition, and the aluminosilicate has a product of the specific surface area in m2/g and the amorphous phase content in the range from 1 to 15. Optionally, at least 50 wt.-% of the aluminosilicate is in an amorphous state. Optionally, the dry particulate composition comprises from 1 wt.-% to 25 wt.-% alkali metal hydroxide, from 15 wt.-% to 50 wt.-% alkali metal silicate, and from 30 wt.-% to 80 wt.-% aluminosilicate, expressed as a proportion of the total weight of the dry particulate composition. Optionally, the dry particulate composition according to any one of the previous claims, wherein the said alkali metal hydroxide is selected from the group consisting of NaOH, KOH, LiOH, RbOH, CsOH, and mixtures thereof. Optionally, the alkali metal of the said alkali metal silicate is selected from the group consisting of Na, K, Li, Rb, Cs, and mixtures thereof. Optionally, the aluminosilicate is selected from the group consisting of metakaolin, fly ash, halloysite, metahalloysite, slag, rock dust, fine sand, activated clay, kaolin, mice, fine feldspar and mixtures thereof. Optionally, at least 50 wt.-% of said aluminosilicate is in an amorphous state, based on the total weight of aluminosilicate in the composition and said aluminosilicate has a product of the specific surface area in m2/g and the amorphous phase content in the range from 5 to 15. Optionally, at least 70 wt.-% of said aluminosilicate is in an amorphous state, based on the total weight of aluminosilicate in the composition and said aluminosilicate has a product of the specific surface area in m2/g and the amorphous phase content in the range from 10 to 15. Optionally, the aluminosilicate has a product of the specific surface area in m2/g and the amorphous phase content in the range from 7 to 15, or from 8 to 15, or from 10 to 15.

The curing of the precursor material may involve exposing the precursor material to a suitable curing gas, such as carbon dioxide. The shaped item may be produced by shell-curing of the precursor material to form the synthetic marble-like material. The shell-curing may involve: providing a porous mould, disposing the precursor material in the porous mould, injecting a curing gas into the porous mould, such that it is transported through the pores of the mould and contacts the precursor material, curing the precursor material to form the shaped item, in the form of a layer of synthetic marble-like material on the surface of the mould, and, optionally, if there is still precursor material in the mould overlying the layer of synthetic marble-like material, disposing of the precursor material, and removing the shaped item.

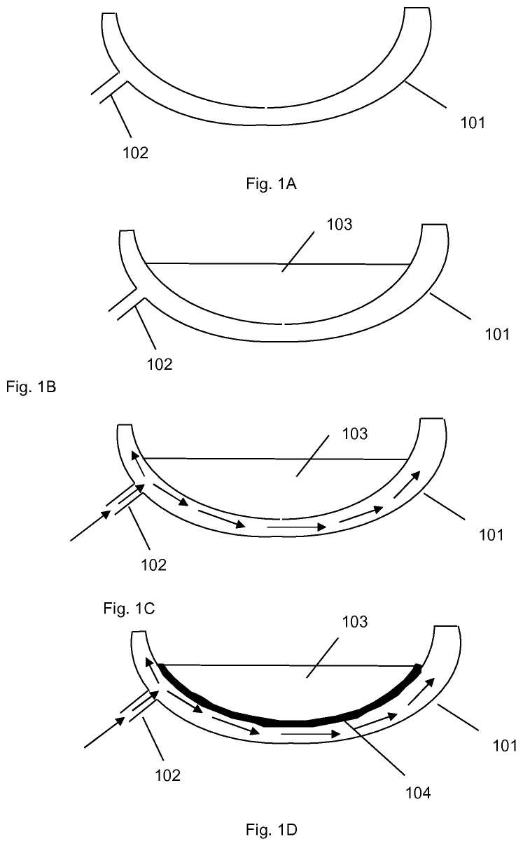

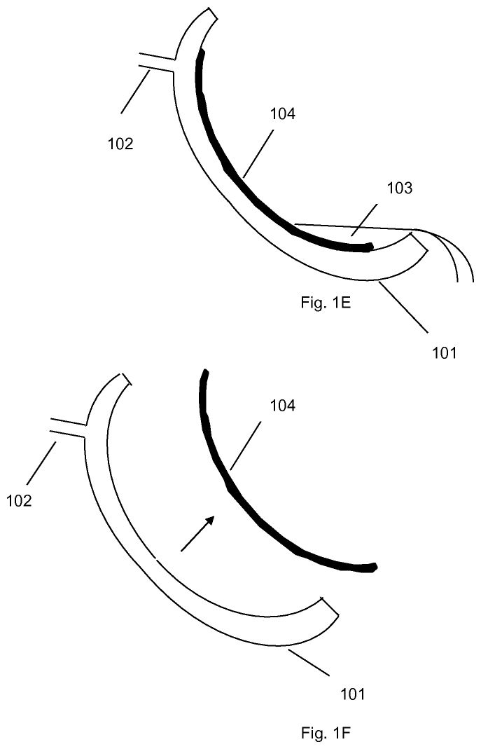

An example of shell-curing is shown in FIG. 1. In FIG. 1A is shown a porous mould 101, having a conduit 102 attached thereto for injecting a curing gas, such as carbon dioxide, into the mould. In FIG. 1B, a precursor material 103 has been disposed in the mould 101. In FIG. 10, a curing gas, such as carbon dioxide, is injected through conduit 102 into the porous mould 101, such that it travels through the pores of the body and contacts the precursor material 103. The body may be heated at the same time, effecting a curing of the precursor material to form a layer of synthetic marble-like material 104 on the inner surface of the mould, which is shown in FIG. 1D. Once the curing is finished, e.g. by stopping the flow of the curing gas and/or reducing the temperature, the shaped item 104 is finished. As shown in FIG. 1E, the excess precursor material that may still be in the mould 101, overlying the shaped item 104, can be poured away. As shown in FIG. 1F, once the precursor material has been removed, the shaped item 104 can be removed from the mould 101.

In an embodiment, a protective layer may be applied over at least one surface of the shaped item, e.g. over a surface of the synthetic marble-like material. The protective layer may be a layer that acts as a water-proofing layer, i.e. increasing the resistance of the shaped item to water ingress or absorption. The material of the protective layer may, for example, be selected from a polymeric material, a wax, an oil (such as linen oil), a mineral, such as sodium or calcium silicates (e.g. water glass). The protective layer may be a ceramic glaze, which may be applied to a surface of the synthetic marble-like material.

1. A shaped item comprising a synthetic marble-like material, wherein the shaped item is an item of sanitary ware and/or has a feature selected from a convex surface, a concave surface and an aperture, which may extend partially or completely through the shaped item, wherein the synthetic marble-like material comprises a composite material comprising a plurality of filler particles and a plurality of adherent bodies, wherein each adherent body includes a core comprising an alkali earth metal silicate, a silica-containing first or inner layer, and an alkali earth metal carbonate-containing second or outer layer, wherein the plurality of adherent bodies and the plurality of filler particles together form one or more bonding matrices and the adherent bodies and the filler particles may be substantially evenly dispersed therein and bonded together.

2. The item according to claim 1, wherein the item is an item of sanitary ware selected from a toilet bowl, a shower receiver, a bath tub, a wash bowl, a urinal, a strainer for a urinal, or a flush tank for a toilet or a urinal.

3. The item according to claim 1, wherein the adherent bodies have been formed from particles comprising a calcium silicate, by the reaction with CO₂, to form the first or inner layer and the second or outer layer of the adherent bodies.

4. (canceled)

5. The item according to claim 1, wherein the filler particles comprise calcium carbonate.

6. The item according to claim 1, wherein the filler particles comprise a material selected from limestone, chamottes, feldspars, quartz, kaolins, mica, calcium carbonate, alumina, corundum, frit and glass cullet.

7. The item according to claim 1, wherein the weight ratio of adherent bodies:filler particles is from about 15:85 to 50:50.

8. The item according to claim 1, wherein the item comprises a substrate having a layer of the synthetic marble-like material thereon.

9. The item according to claim 8, wherein the substrate comprises a porous inorganic material.

10. The item according to claim 9, wherein the porous inorganic material is selected from a porous geopolymer, porous concrete, glass foam, glass wool, expanded perlite, expanded clay, and consolidated diatomite earth.

11. The item according to claim 9, wherein the item is producible by providing the substrate, which is a porous structure having open pores on a surface thereof, and applying a precursor for the synthetic marble-like material on the surface having the open pores, such that at least some of the pores are at least partially filled with the precursor material, and curing the precursor to form the synthetic marble-like material.

12. The item according to claim 1, wherein a protective layer has been applied over at least one surface of the synthetic marble-like material.

13. The item according to claim 12, wherein the protective layer comprises a material selected from a polymeric material and an inorganic material.

14. A method for making a shaped item comprising a synthetic marble-like material, wherein the synthetic marble-like material comprises a composite material comprising a plurality of filler particles and a plurality of adherent bodies, wherein each adherent body includes a core comprising an alkali earth metal silicate, a silica-containing first or inner layer, and an alkali earth metal carbonate-containing second or outer layer, and wherein the plurality of adherent bodies and the plurality of filler particles together form one or more bonding matrices and the adherent bodies and the filler particles may be substantially evenly dispersed therein and bonded together, the method comprising
providing a mixture of (i) precursor particles comprising an alkali earth metal silicate and (ii) filler particles, which together form a precursor to the synthetic marble-like material, and
reacting the precursor particles with CO₂ to form the adherent bodies having a core of an alkali earth metal silicate and a silica-containing first or inner layer, and an alkali earth metal carbonate-containing second or outer layer, such that the adherent bodies and filler particles are bonded together in one or more matrices to form the synthetic marble-like material,
wherein the shaped item is an item of sanitary ware and/or has a feature selected from a convex surface, a concave surface and an aperture, which may extend partially or completely through the shaped item.

15. A method according to claim 14, wherein the reacting involves hydrothermal liquid phase sintering (HLPS).

16. A method according to claim 14, wherein the method involves mixing a particulate composition and a liquid composition to form a slurry mixture, wherein the particulate composition comprises the precursor particles comprising a ground calcium silicate, and
the filler particles comprise a first ground calcium carbonate,
and wherein the liquid composition comprises:
water;
casting the slurry mixture in a mold or on a substrate; and
curing the casted mixture at a temperature in the range from about 20° C. to about 150° C. for about 1 hour to about 80 hours under an atmosphere of water and CO₂ to produce the synthetic marble-like material.

17. A method according to claim 16, wherein the precursor particles comprising the ground calcium silicate have a median particle size in the range from about 1 μm to about 100 μm.

18-22. (canceled)

23. A method according to claim 14, wherein the method involves providing a porous mould, disposing a precursor material comprising (i) the precursor particles comprising an alkali earth metal silicate and (ii) filler particles in the porous mould, injecting a curing gas comprising CO₂ into the porous mould, such that it is transported through the pores of the mould and contacts the precursor material, curing the precursor material to form the shaped item, in the form of a layer of synthetic marble-like material on the surface of the mould, and removing the shaped item from the mould.

24. A method according to claim 14, wherein the method involves forming the synthetic marble-like material on a substrate, to which the synthetic marble-like material adheres.

25-27. (canceled)

28. A method according to claim 14, wherein the substrate is selected from a porous geopolymer, porous concrete, glass foam, glass wool, expanded perlite, expanded clay, and consolidated diatomite earth.

29. A method according to claim 14, wherein the item is an item of sanitary ware selected from a toilet bowl, a shower receiver, a bath tub, a wash bowl, a urinal, a strainer for a urinal, and a flush tank for a toilet or a urinal.
